(19) United States
(12) Patent Application Publication
(10) Pub. No.: US 2026/0319193 A1
(43) Pub. Date: Oct. 15, 2026

(54) PHOTONIC INTEGRATED CIRCUIT

(71) Applicant: MediaTek Singapore Pte. Ltd., Singapore (SG)

(72) Inventors: Lian DUAN, Singapore (SG); Zhigang DUAN, Singapore (SG)

(21) Appl. No.: 19/640,560

(22) Filed: Apr. 7, 2026

Related U.S. Application Data
(60) Provisional application No. 63/787,249, filed on Apr. 11, 2025.

(51) Int. Cl. G02B 6/42

(52) U.S. Cl. CPC G02B 6/4206; G02B 6/4243; G02B 6/4244; G02B 6/4251

(57) ABSTRACT

A photonic integrated circuit is provided. The photonic integrated circuit includes an internal circuit, a seal ring, and a spot-size converter (SSC). The seal ring continuously surrounds the internal circuit. The spot-size converter (SSC) is connected between the internal circuit and an external fiber. The seal ring includes a hole for the SSC to pass through.

### CROSS REFERENCE TO RELATED APPLICATIONS

This application claims the benefit of U.S. provisional application No. 63/787,249, filed Apr. 11, 2025, the entirety of which is incorporated by reference herein.

### TECHNICAL FIELD

The present disclosure relates to a photonic integrated circuit, and, in particular, it relates to a seal ring of a photonic integrated circuit.

### BACKGROUND

A photonic integrated circuit (PIC) is an electronic circuit that integrates optical components, such as waveguides, modulators, and lasers, all on a single chip. In comparison, an electronic integrated circuit (EIC) only integrates electronic devices, like transistors and capacitors, on a single chip. In its simplest terms, PIC is often used to denote a photonics chip containing photonics components that manipulate and transmit light. PICs transmit data at high speeds, using light instead of electricity, resulting in faster data transmission speeds, lower power consumption, and higher bandwidth.

Therefore, there is a strong need in this industry to provide a PIC with improved performance.

### BRIEF SUMMARY

An embodiment of the present disclosure provides a photonic integrated circuit. The photonic integrated circuit includes an internal circuit, a seal ring, and a spot-size converter (SSC). The seal ring continuously surrounds the internal circuit. The spot-size converter (SSC) is connected between the internal circuit and an external fiber. The seal ring includes a hole for the SSC to pass through.

An embodiment of the present disclosure provides a photonic integrated circuit. The photonic integrated circuit includes an internal circuit, a seal ring, and a spot-size converter (SSC). The seal ring surrounds the internal circuit. The spot-size converter (SSC) is connected between the internal circuit and an external fiber. The seal ring includes a plurality of metal layers and a hole to allow the SSC to pass through, and the hole is formed in a portion of the plurality of metal layers.

Another embodiment of the present disclosure provides a photonic integrated circuit. The photonic integrated circuit includes an internal circuit, a seal ring, a spot-size converter (SSC), a V-groove, and a first barrier bar. The seal ring surrounds the internal circuit. The spot-size converter (SSC) passes through an opening in the seal ring and connected between the internal circuit and an external fiber. The V-groove is located outside the seal ring and positioned adjacent to the seal ring, wherein the external fiber is disposed within the V-groove. The first barrier bar is connected to the seal ring. The first barrier bar contacts an inner sidewall of the V-groove and is spaced apart from the external fiber.

### BRIEF DESCRIPTION OF THE DRAWINGS

The present disclosure can be more fully understood by reading the subsequent detailed description and examples with references made to the accompanying drawings, wherein:

FIG. 1 is a schematic perspective view of a photonic integrated circuit in accordance with some embodiments of the disclosure;

FIG. 2 is a schematic cross-sectional view along the line A-A’ of the photonic integrated circuit in accordance with some embodiments of the disclosure shown in FIG. 1;

FIG. 3 is a schematic cross-sectional view along the line A-A’ of the photonic integrated circuit in accordance with some embodiments of the disclosure shown in FIG. 1;

FIG. 4 is a schematic cross-sectional view along the line A-A’ of the photonic integrated circuit in accordance with some embodiments of the disclosure shown in FIG. 1;

FIG. 5 is a schematic top view of a photonic integrated circuit in accordance with some embodiments of the disclosure; and

FIG. 6 is an enlarge view of the photonic integrated circuit in accordance with some embodiments of the disclosure shown in FIG. 5.

### DETAILED DESCRIPTION

The following description is made for the purpose of illustrating the general principles of the disclosure and should not be taken in a limiting sense. The scope of the disclosure is best determined by reference to the appended claims.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items. As used in the embodiments and descriptions herein, the term “substantially” means that a value may deviate from a referenced value within an industrial tolerance, for example, by about 5%, 10%, 20%, or other similar deviations.

In the conventional photonic integrated circuit (or photonic chip) design, the spot-size converter (SSC) is essential for efficient light coupling, but it requires a discontinuous seal ring for light passage. The discontinuous seal ring, however, allows moisture to enter the chip, potentially degrading its performance. Thus, a novel seal ring for improvement in durability and performance of PIC chip is desirable.

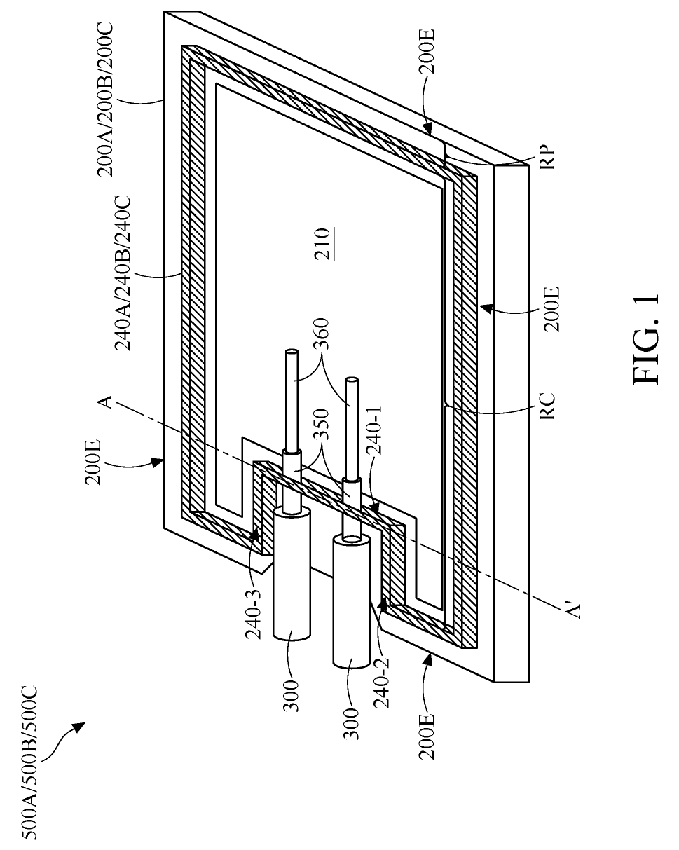

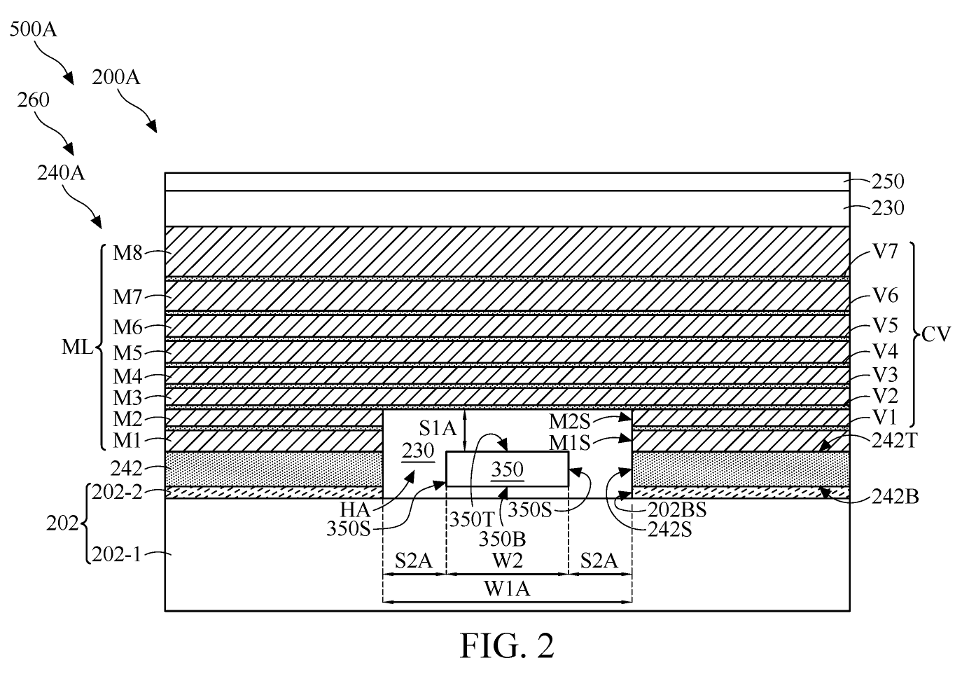

FIG. 1 is a schematic perspective view of a photonic integrated circuit 500A in accordance with some embodiments of the disclosure. FIG. 2 is a schematic cross-sectional view along the line A-A’ of the photonic integrated circuit 500A in accordance with some embodiments of the disclosure shown in FIG. 1. For illustration, dielectric layers of an interconnect structure of the photonic integrated circuit 500A are omitted in FIG. 1.

As shown in FIGS. 1 and 2, the photonic integrated circuit 500A includes a chip (or die) 200A, one or more external fibers 300 and a spot-size converter (SSC) 350.

The chip 200A may include a semiconductor substrate 202, an internal circuit 210, dielectric layers 230 and a seal ring 240A. The chip 200A may include at least one V-groove (not shown) configured to receive at least one external fiber 300, wherein the number of V-grooves may correspond to the number of external fibers 300. The at least one V-grooves is located outside the seal ring and is positioned adjacent to (i.e., close to) the seal ring. Each V-groove may be a V-shaped trench formed on the semiconductor substrate 202. The closer a V-groove is to the top surface of the semiconductor substrate 202, the larger its opening width, thereby facilitating secure and stable positioning of the external fiber 300.

The chip 200A has a circuit region RC and a peripheral region RP surrounding the circuit region RC. The peripheral region RP is close to edges 200E of the chip 200A. In some embodiments, the semiconductor substrate 202 may include silicon. In alternative embodiments, SiGe, bulk semiconductor, strained semiconductor, compound semiconductor, semiconductor-on-insulator (SOI), and other commonly used semiconductor substrates can be used for the semiconductor substrate 202. In some embodiments, the semiconductor substrate 202 is included in a SOI substrate. The SOI substrate may include an insulating layer (not shown), an oxide layer 202-1, and a silicon layer 202-2. The oxide layer 202-1 is formed over the insulating layer (not shown). The silicon layer 202-2 is formed over the oxide layer 202-1. In some embodiments, the oxide layer 202-1 includes silicon oxide. In some embodiments, the silicon layer 202-2 is provided to form a waveguide 360 and the internal circuit 210.

The semiconductor substrate 202 may have the desired conductivity type by implanting p-type or n-type impurities. In some embodiments, an insulating feature including a buried oxide layer and shallow trench isolation (STI) features (not shown) is formed on the top of the semiconductor substrate 202. The insulating feature may surround the internal circuit 210 and provide physical and electrical isolation of the internal circuit 210 in active regions (not shown) on the semiconductor substrate 202.

The internal circuit 210 is disposed on the semiconductor substrate 202 in the circuit region RC. In some embodiments, the internal circuit 210 may include a photonic integrated circuit (PIC) composed of photonic components, such as photodetectors, grating couplers, modulators, and lasers. The internal circuit 210 may also include electrical routings (including conductive layer patterns (not shown) belong to the first conductive layer M1, the second metal layer M2, the third metal layer M3, the fourth metal layer M4, the fifth metal layer M5, the sixth metal layer M6, the seventh metal layer M7, and the eighth conductive layer M8 and conductive vias belong to the first via V1, the second conductive via V2, the third conductive via V3, the fourth conductive via V4, the fifth conductive via V5, the sixth conductive via V6, and the seventh via V7 of an interconnect structure 260) connected to the photonic components.

In some embodiments, the waveguide 360 of the chip 200A is disposed on the semiconductor substrate 202 and adjacent to the internal circuit 210. In addition, the waveguide 360 is coupled to the internal circuit 210. In some embodiments, the waveguide 360 is a semiconductor waveguide (e.g., a silicon waveguide).

The interconnect structure 260 of the chip 200A is disposed on the semiconductor substrate 202. The internal circuit 210 may be covered by and embedded in the interconnect structure 260. In some embodiments, the interconnect structure 260 includes the dielectric layers 230 and the seal ring 240A.

The dielectric layers 230 are disposed on the semiconductor substrate 202. The dielectric layers 230 are laminated vertically on the semiconductor substrate 202. The dielectric layer 230 may serve as interlayer dielectric (ILD) layer or intermetal dielectric (IMD) layers. In some embodiments, the dielectric layer 230 may be made of silicon oxide, silicon oxynitride, un-doped silicate glass (USG), borosilicate glass (BSG), phosphoric silicate glass (PSG), borophosphosilicate glass (BPSG), fluorinated silicate glass (FSG), or a combination thereof. In some embodiments, the dielectric layers 230 may be made of a low-k dielectric material (e.g., a dielectric constant that is less than a dielectric constant of silicon dioxide) with a dielectric constant (k) between about 2.9 and 3.8, an ultra low-k dielectric material with a dielectric constant (k) between about 2.5 and 3.9 and/or an extreme low-k (ELK) dielectric material with a dielectric constant (k) less than about 2.5. For example, the dielectric layers 230 may include carbon doped oxide, porous carbon doped silicon dioxide, a polymer such as polyimide or silicon oxycarbide polymer (SiOC), or combinations thereof. In some embodiments, the dielectric layer 230 is formed by plasma enhanced chemical vapor deposition (PECVD). It is noted that the number of (low-k) dielectric layers 230 are defined by the costumer design and the scope of the disclosure is not limited.

The spot-size converter (SSC) 350 is disposed on the semiconductor substrate 202. The spot-size converter (SSC) 350 may extend from the peripheral region RP into the circuit region RC. In addition, the SSC 350 is connected and optically coupled between the internal circuit 210 and the external fiber 300 (e.g., an optical fiber).

In some embodiments, the SSC 350 may be made of silicon, silicon nitride (SiN) or other applicable materials.

The seal ring 240A is disposed on the oxide layer 202-1 of the semiconductor substrate 202. The seal ring 240A is located between the circuit region RC and the peripheral region RP and continuously surrounds the circuit region RC without breakpoints. In addition, the seal ring 240A may continuously surround the internal circuit 210 and the waveguide 360. In some embodiments, the seal ring 240A may include the silicon layer 202-2, a contact layer 242, multi levels of metal layers ML, and multi levels of conductive vias CV embedded in the dielectric layers 230. The seal ring 240A may further comprise the dielectric layer 230, and a passivation layer 250 on the dielectric layer 230. For example, as shown in FIG. 1, the seal ring 240A may have 8 levels of metal layers ML respectively denoted as the first metal layer M1, the second metal layer M2, the third metal layer M3, the fourth metal layer M4, the fifth metal layer M5, the sixth metal layer M6, the seventh metal layer M7, and the eighth metal layer M8, from bottom to top. The contact layer 242 is disposed directly below and coupled to the first metal layer M1.

In addition, the seal ring 240A may have multi levels of conductive vias CV alternately arranged with and electrically connected (coupled) to the metal layers ML. For example, as shown in FIG. 1, the seal ring 240A may have 7 levels of conductive vias CV respectively denoted as the first conductive via V1, the second conductive via V2, the third conductive via V3, the fourth conductive via V4, the fifth conductive via V5, the sixth conductive via V6, and the seventh conductive via V7, from bottom to top. The first conductive via V1 is coupled between the first metal layer M1 and the second metal layer M2. The second conductive via V2 is coupled between the second metal layer M2 and the third metal layer M3. The third conductive via V3 is coupled between the third metal layer M3 and the fourth metal layer M4. The fourth conductive via V4 is coupled between the fourth metal layer M4 and the fifth metal layer M5. The fifth conductive via V5 is coupled between the fifth metal layer M5 and the sixth metal layer M6. The sixth conductive via V6 is coupled between the sixth metal layer M6 and the seventh metal layer M7. The seventh conductive via V7 is coupled between the seventh metal layer M7 and the eighth metal layer M8.

In some embodiments, the conductive vias CV are via bars. The conductive vias CV may have top-view shapes corresponding to the top-view shapes of upper metal layers ML.

In some embodiments, the contact layer 242 may be made of metal, such as tungsten. In some embodiments, the metal layer ML and the conductive vias CV may be made of metal, such as copper (Cu), aluminum (Al) or an alloy thereof.

It is noted that the number of metal layers ML and the number of conductive vias CV of the seal ring 240A are defined by the costumer design and the scope of the disclosure is not limited.

As shown in FIG. 2, the seal ring 240A may include a hole (opening) HA for the SSC 350 to pass through it. As shown in FIG. 1, the seal ring 240A may include a first ring portion 240-1, and the hole (opening) HA is located in the first ring portion 240-1. The seal ring 240A may further include a first ring portion 240-2 and a third ring portion 240-3. The second ring portion 240-2 and the third ring portion 240-3 are respectively connected to two opposite ends of the first ring portion 240-1. The V-groove and the external fiber 300 may be disposed in the space between the second ring portion 240-2 and the third ring portion 240-3. In some embodiments, the longitudinal extension direction of the V-groove, the external fiber 300, and the SSC 350 is substantially perpendicular to the longitudinal extension direction of the first ring portion 240-1. The longitudinal extension directions of the second ring portion 240-2 and the third ring portion 240-3 are substantially perpendicular to that of the first ring portion 240-1. Accordingly, the longitudinal extension directions of the V-groove, the external fiber 300, and the SSC 350 are substantially parallel to those of the second ring portion 240-2 and the third ring portion 240-3. The seal ring 240A may further include additional ring portions to form a seal ring of a desired shape. In some embodiments, the SSC 350 is separated from the metal layers ML and the conductive vias CV of the seal ring 240A by the dielectric layers 230. In some embodiments, the hole HA is formed at least in the bottom metal layer (e.g., the first metal layer M1) and the metal layer (e.g., the second metal layer M2) that is immediately over the bottom metal layer among the metal layers ML in the seal ring 240A. For example, the hole HA is formed at least in the contact layer 242, the first metal layer M1, the first conductive via V1, the second metal layer M2, and the second conductive via V2. More specifically, in the seal ring 240A, the contact layer 242, the first metal layer M1, the second metal layer M2, and the first conductive via V1 are discontinuous. In addition, the third metal layer M3, the fourth metal layer M4, the fifth metal layer M5, the sixth metal layer M6, the seventh metal layer M7, the eighth metal layer M8, the second conductive via V2, the third conductive via V3, the fourth conductive via V4, the fifth conductive via V5, the sixth conductive via V6, and the seventh conductive via V7 are continuous. In some embodiments, the seal ring 240A includes a plurality of metal layers (M1–M8), and the hole HA is formed in only a portion (i.e., some) of the metal layers rather than in all of the metal layers. Accordingly, the seal ring 240A remains continuous.

In some embodiments, the third metal layer M3, the fourth metal layer M4, the fifth metal layer M5, the sixth metal layer M6, the seventh metal layer M7, the eighth metal layer M8, the second conductive via V2, the third conductive via V3, the fourth conductive via V4, the fifth conductive via V5, the sixth conductive via V6, and the seventh conductive via V7 may cover discontinuous regions of the contact layer 242, the first metal layer M1, the second metal layer M2, and the first conductive via V1. In some embodiments, the discontinuous regions of the contact layer 242, the first metal layer M1, the second metal layer M2, and the first conductive via V1 may overlap each other, and they have the same width W1A.

In some embodiments, a sidewall 242S of the contact layer 242, a sidewall M1S of the first metal layer M1, and a sidewall M2S of the second metal layer M2 used to define the hole HA are aligned with other.

In some embodiments, the hole HA may extend into the silicon layer 202-2 of the semiconductor substrate 202. The width (not shown) of the discontinuous region of the silicon layer 202-2 may the same as the width W1A of the discontinuous regions of the contact layer 242, the first metal layer M1, the second metal layer M2, and the first conductive via V1. In addition, a sidewall 202-2S of the silicon layer 202-2 of the semiconductor substrate 202 is aligned with the corresponding sidewalls 242S and M1S, and M2S.

In some embodiments, the width W1A of the discontinuous regions of the contact layer 242, the first metal layer M1, the second metal layer M2, and the first conductive via V1 may also serve as the width W1A of the hole HA. In some embodiments, the width W1A of the hole HA may keep a fixed value. In the cross-section view, the hole HA may have a rectangular shape.

The SSC 350 may pass through the discontinuous regions of the contact layer 242, the first metal layer M1, the second metal layer M2, and the first conductive via V1. The SSC 350 SSC is separated from the metal layers ML by the dielectric layer(s) 230.

In some embodiments, the bottom surface 350B of the SSC 350 may be substantially flush with the bottom surface of the seal ring 240A. For example, the bottom surface 350B of the SSC 350 may be flush with the bottom surface of the silicon layer 202-2. In some embodiments, the bottom surface 350B of the SSC 350 is substantially flush with the other surface. For example, the bottom surface 350B of the SSC 350 may be flush with the bottom surface 242B of the contact layer 242. The top surface 350T of the SSC 350 may be flush with the top surface 242T of the contact layer 242.

In some embodiments, the spacing S1A between the hole HA and the top surface 350T of the SSC 350 may be greater than, less than or equal to the same as the width W2 of the SSC 350, such as about 2-3 μm. In some embodiments, the spacing S2A between the hole HA and the side surface 350S of the SSC 350 is the same as the spacing S1A and the width W2 of the SSC 350, such as about 2-3 μm. In some embodiments, the maximum width W1A of the hole HA is substantially the same as three times the width W2 of the SSC 350, such as about 6-9 μm.

When the spacing S1A, the spacing S2A, and the maximum width W2 are properly controlled within suitable ranges, moisture penetration through the seal ring 240A can be effectively prevented, thereby protecting the internal circuit 210. Furthermore, by appropriately setting the spacing S1A and the spacing S2A, signal transmission through the SSC 350 can be made more stable and reliable, thereby reducing interference from the metal layers.

In some embodiments, the interconnect structure 260 further includes one or more passivation layers 250. The passivation layer 250 is subsequently deposited above the semiconductor substrate 202 and cover the seal ring 240A. In some embodiments, the passivation layer 250 including a single-layer structure or a multi-layer structure is formed of silicon oxide or silicon nitride. In some embodiments, the passivation layer 250 has a multi-layer structure including an inorganic passivation layer (e.g., silicon oxide or silicon nitride) and an organic passivation layer (e.g., solder mask or polyimide) on the inorganic passivation layer.

The photonic integrated circuit 500A aims to redesign the seal ring 240A having a rectangular hole HA formed at least in the bottom metal layer (e.g., the first metal layer M1) and the metal layer (e.g., the second metal layer M2) that is immediately over the bottom one of the metal layers ML in the seal ring 240A. In addition, the hole HA may extend into a portion of the semiconductor substrate (e.g., the silicon layer 202-2 of the semiconductor substrate 202). The seal ring 240A can block moisture while still enabling the SSC's (e.g., the SSC 350) function, thus enhancing the chip's durability and performance. The novel seal ring 240A can maintain light access but prevents moisture ingress. The seal ring 2340A include a narrow hole HA to minimize copper loss (the discontinuous area of the seal ring 240A) and to position the metal as close as possible to the SSC 350. The photonic integrated circuit 500A may further reduce the size of the hole HA of the seal ring 240A and minimize moisture ingress. In some embodiments, the hole HA can be sealed at upper metal layers form the third metal layer M3 or the third metal layer M4. In some embodiments, the bottom surface 350B of the SSC 350 is substantially flush with the bottom surface of the seal ring 240A.

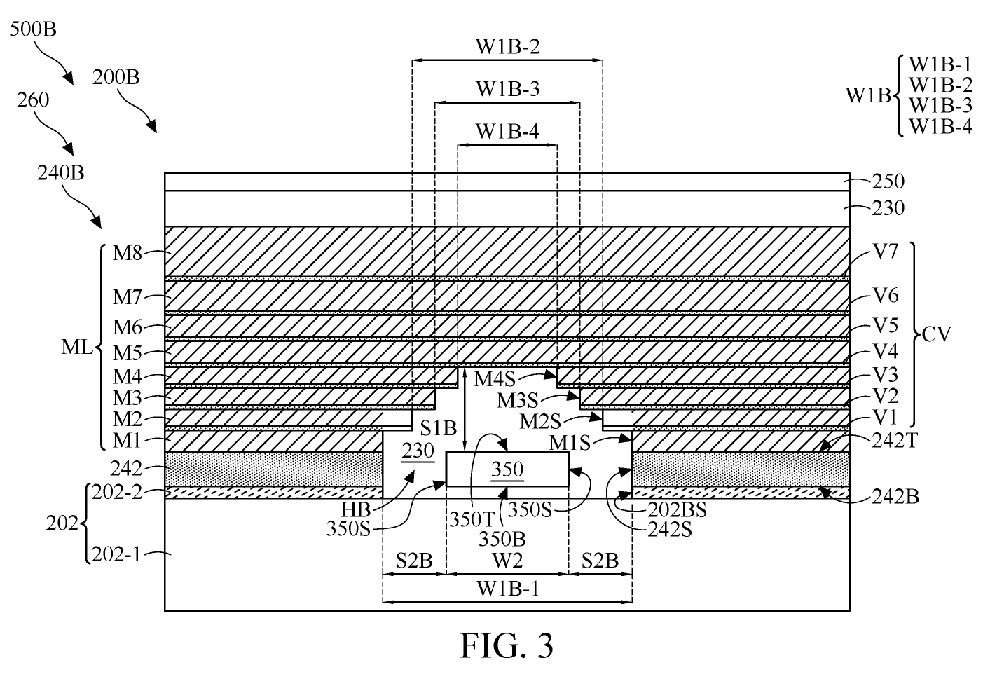

FIG. 1 is also a schematic perspective view of a photonic integrated circuit 500B in accordance with some embodiments of the disclosure. FIG. 3 is a schematic cross-sectional view along the line A-A’ of the photonic integrated circuit 500B in accordance with some embodiments of the disclosure shown in FIG. 1. Elements of the embodiments that are the same or similar to those previously described with reference to FIGS. 1 and 2 are not repeated herein, in the interests of brevity. For illustration, dielectric layers of an interconnect structure of the photonic integrated circuit 500B are omitted in FIG. 2.

As shown in FIGS. 2 and 3, the difference between the photonic integrated circuit 500A and the photonic integrated circuit 500B at least includes that the photonic integrated circuit 500B may include a seal ring 240B having a reverse taper hole HB (opening).

As shown in FIGS. 1 and 3, the photonic integrated circuit 500B includes a chip 200B, one or more external fibers 300 and a spot-size converter (SSC) 350.

The chip 200B may include a semiconductor substrate 202, an internal circuit 210, dielectric layers 230 and the seal ring 240B.

The seal ring 240B is disposed on the oxide layer 202-1 of the semiconductor substrate 202. The seal ring 240B is located between the circuit region RC and the peripheral region RP and surrounds the circuit region RC. In addition, the seal ring 240B may continuously surround the internal circuit 210 and the waveguide 360. In some embodiments, the seal ring 240B may include the silicon layer 202-2, a contact layer 242, multi levels of metal layers ML (e.g., the first metal layer M1, the second metal layer M2, the third metal layer M3, the fourth metal layer M4, the sixth metal layer M6, the seventh metal layer M7, and the eighth metal layer M8), and multi levels of conductive vias CV (e.g., the first conductive via V1, the second conductive via V2, the third conductive via V3, the fourth conductive via V4, the fifth conductive via V5, the sixth conductive via V6, and the seventh conductive via V7) embedded in the dielectric layers 230. The seal ring 240B may further comprise the dielectric layer 230, and the passivation layer 250.

As shown in FIG. 3, the seal ring 240B may include a hole (discontinuous region) HB for the SSC 350 to pass through it. In addition, the SSC 350 is separated from the metal layers ML and the conductive vias CV by the dielectric layer(s) 230. In some embodiments, the hole HB (opening) is formed at least in the bottom metal layer (e.g., the first metal layer M1) and the metal layer (e.g., the second metal layer M2) that is immediately over the bottom metal layer in the seal ring 240B. For example, the hole HB is formed in the contact layer 242, the first metal layer M1, the first conductive via V1, and the second metal layer M2, the second conductive via V2, the third metal layer M3, the third conductive via V3, and the fourth metal layer M4. More specifically, in the seal ring 240B, the contact layer 242, the first metal layer M1, the second metal layer M2, the third metal layer M3, the fourth metal layer M4, the first conductive via V1, the second conductive via V2, and the third conductive via V3 are discontinuous. In addition, the fifth metal layer M5, the sixth metal layer M6, the seventh metal layer M7, the eighth metal layer M8, the fourth conductive via V4, the fifth conductive via V5, the sixth conductive via V6, and the seventh conductive via V7 are continuous. In some embodiments, the seal ring 240B includes a plurality of metal layers (M1–M8), and the hole HB is formed in only a portion (i.e., some) of the metal layers rather than in all of the metal layers. Accordingly, the seal ring 240B remains continuous.

In some embodiments, the fifth metal layer M5, the sixth metal layer M6, the seventh metal layer M7, the eighth metal layer M8, the fourth conductive via V4, the fifth conductive via V5, the sixth conductive via V6, and the seventh conductive via V7 may cover discontinuous regions of the contact layer 242, the first metal layer M1, the second metal layer M2, and the first conductive via V1.

In some embodiments, the width of the discontinuous region of the contact layer 242 is the same as the width W1B-1 of the discontinuous region of the first metal layer M1. In addition, a sidewall 242S of the contact layer 242 and a sidewall M1S of the first metal layer M1 used to define the hole HB are aligned with each other.

In some embodiments, the discontinuous regions of the first metal layer M1, the second metal layer M2, the third metal layer M3, the fourth metal layer M4, and the first conductive via V1, the second conductive via V2, and the third conductive via V3 may overlap each other, and they have different widths W1B. For example, the width W1B-1 of the discontinuous region of the first metal layer M1, the width W1B-2 of the discontinuous region of the second metal layer M2, the width W1B-3 of the discontinuous region of the third metal layer M3, and the width W1B-4 of the discontinuous region of the fourth metal layer M4 may decrease gradually toward the top surface 240BT of the seal ring 240B.

In some embodiments, a sidewall M2S of the second metal layer M2, a sidewall M3S of the third metal layer M3, a sidewall M4S of the fourth metal layer M4 used to define the hole HB are not aligned with the corresponding sidewalls 242S and M1S.

Similarly, the widths of the discontinuous regions of the first conductive via V1, the second conductive via V2, and the third conductive via V3 may decrease gradually toward the top surface 240BT of the seal ring 240B.

In some embodiments, the hole HB may extend into the silicon layer 202-2 of the semiconductor substrate 202. The width (not shown) of the discontinuous region of the silicon layer 202-2 may the same as the width (i.e., the width W1B-1) of the discontinuous region of the contact layer 242 and the width W1B-1 of the discontinuous region of the first metal layer M1. In addition, a sidewall 202-2S of the silicon layer 202-2 of the semiconductor substrate 202 is aligned with the corresponding sidewalls 242S and M1S.

In some embodiments, the width W1B of the discontinuous regions of the contact layer 242, the first metal layer M1, the second metal layer M2, the third metal layer M3, the fourth metal layer M4, and the first conductive via V1, the second conductive via V2, and the third conductive via V3 may also serve as the width W1B of the hole HB. In some embodiments, the width W1B of the hole HB may decrease gradually toward the top surface 240BT of the seal ring 240B.

In the cross-section view along the extending direction of the seal ring 240B close to the hole HB, the hole HB may have a reverse taper shape.

The SSC 350 is located in discontinuous regions of the contact layer 242, the first metal layer M1, the second metal layer M2, the third metal layer M3, the fourth metal layer M4, and the first conductive via V1, the second conductive via V2, and the third conductive via V3.

In some embodiments, the bottom surface 350B of the SSC 350 is substantially flush with the bottom surface of the seal ring 240B. For example, the bottom surface 350B of the SSC 350 may be flush with the bottom surface 242B of the contact layer 242 (i.e., the bottom surface of the seal ring 240B). The top surface 350T of the SSC 350 may be flush with the top surface 242T of the contact layer 242.

In some embodiments, the spacing S1B between the hole HB and the top surface 350T of the SSC 350 is greater than as the width W2 of the SSC 350. In some embodiments, the maximum spacing S2B between the hole HB and the side surface 350S of the SSC 350 is the same as the width W2 of the SSC 350, such as about 2-3 μm. In some embodiments, the maximum width W1B of the hole HB is substantially the same as three times the width W2 of the SSC 350, such as about 6-9 μm. In some embodiments, the minimum width W1B of the hole HB may smaller than the width W2 of the SSC 350.

When the spacing S1B, the maximum spacing S2B, and the maximum width W1B are maintained within appropriate limits, the seal ring 240B can effectively prevent undesired moisture from penetrating and reaching the internal circuit 210. Furthermore, by appropriately setting spacing S1B and spacing S2B, signal transmission through the SSC 350 can be made more stable and reliable, thereby reducing interference from the metal layers.

The photonic integrated circuit 500B aims to redesign the seal ring 240B having a reverse taper hole HB formed at least in the bottom metal layer (e.g., the first metal layer M1) and the metal layer (e.g., the second metal layer M2) that is immediately over the bottom metal layer in the seal ring 240B. In addition, the hole HB may extend into a portion of the semiconductor substrate (e.g., the silicon layer 202-2 of the semiconductor substrate 202). The seal ring 240B can block moisture while still enabling the SSC's (e.g., the SSC 350) function, thus enhancing the chip's durability and performance. The novel seal ring 240B can maintain light access but prevents moisture ingress. The seal ring 240B include a narrow hole HB to minimize copper loss (the discontinuous area of the seal ring 240B) and to position the metal as close as possible to the SSC 350. The photonic integrated circuit 500B may further reduce the size of the hole HB of the seal ring and minimize moisture ingress. In some embodiments, the hole HB can be gradually closed and sealed at the upper metal layers form the fifth metal layer M5 or the sixth metal layer M6. In some embodiments, the bottom surface 350B of the SSC 350 is substantially flush with the bottom surface of the seal ring 240B.

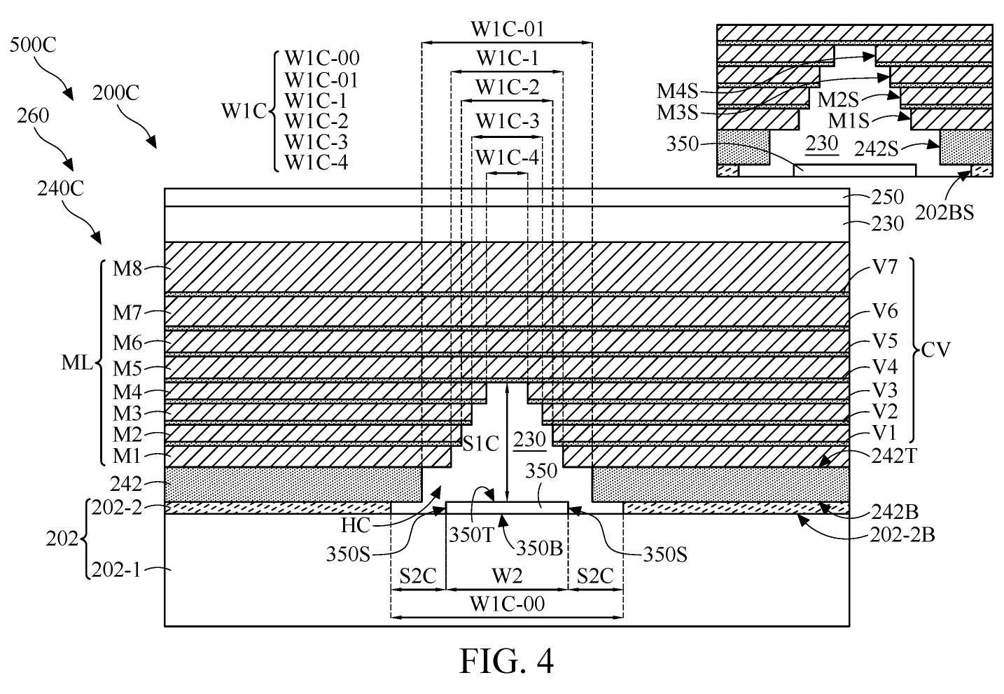

FIG. 1 is also a schematic perspective view of a photonic integrated circuit 500C in accordance with some embodiments of the disclosure. FIG. 4 is a schematic cross-sectional view along the line A-A’ of the photonic integrated circuit 500C in accordance with some embodiments of the disclosure shown in FIG. 1. Elements of the embodiments that are the same or similar to those previously described with reference to FIGS. 1-3 are not repeated herein, in the interests of brevity. For illustration, dielectric layers of an interconnect structure of the photonic integrated circuit 500C are omitted in FIG. 1.

As shown in FIGS. 2 and 4, the difference between the photonic integrated circuit 500A and the photonic integrated circuit 500C at least includes that the photonic integrated circuit 500C may include a seal ring 240C having a reverse taper hole HC (opening).

As shown in FIGS. 1 and 4, the photonic integrated circuit 500C includes a chip 200C, one or more external fibers 300 and a spot-size converter (SSC) 350.

The chip 200C may include a semiconductor substrate 202, an internal circuit 210, dielectric layers 230 and the seal ring 240C.

The seal ring 240C is disposed on the oxide layer 202-1 of the semiconductor substrate 202. The seal ring 240C is located between the circuit region RC and the peripheral region RP and surrounds the circuit region RC. In addition, the seal ring 240C may continuously surround the internal circuit 210 and the waveguide 360. In some embodiments, the seal ring 240C may include a silicon layer 202-2, a contact layer 242, multi levels of metal layers ML (e.g., the first metal layer M1, the second metal layer M2, the third metal layer M3, the fourth metal layer M4, the sixth metal layer M6, the seventh metal layer M7, and the eighth metal layer M8), and multi levels of conductive vias CV (e.g., the first conductive via V1, the second conductive via V2, the third conductive via V3, the fourth conductive via V4, the fifth conductive via V5, the sixth conductive via V6, and the seventh conductive via V7) embedded in the dielectric layers 230. The seal ring 240C may further comprise the dielectric layer 230, and the passivation layer 250.

As shown in FIG. 3, the seal ring 240C may include a hole (discontinuous region) HC for the SSC 350 to pass through it. In addition, the SSC 350 is separated from the metal layers ML and the conductive vias CV by the dielectric layer(s) 230. In some embodiments, the hole HC (opening) is formed at least in the bottom metal layer (e.g., the first metal layer M1) and the metal layer (e.g., the second metal layer M2) that is immediately over the bottom metal layer in the seal ring 240C. For example, the hole HC is formed in the contact layer 242, the first metal layer M1, the first conductive via V1, and the second metal layer M2, the second conductive via V2, the third metal layer M3, the third conductive via V3, and the fourth metal layer M4. More specifically, in the seal ring 240C, the contact layer 242, the first metal layer M1, the second metal layer M2, the third metal layer M3, the fourth metal layer M4, the first conductive via V1, the second conductive via V2, and the third conductive via V3 are discontinuous. In addition, the fifth metal layer M5, the sixth metal layer M6, the seventh metal layer M7, the eighth metal layer M8, the fourth conductive via V4, the fifth conductive via V5, the sixth conductive via V6, and the seventh conductive via V7 are continuous. In some embodiments, the seal ring 240C includes a plurality of metal layers (M1–M8), and the hole HC is formed in only a portion (i.e., some) of the metal layers rather than in all of the metal layers. Accordingly, the seal ring 240C remains continuous.

In some embodiments, the fifth metal layer M5, the sixth metal layer M6, the seventh metal layer M7, the eighth metal layer M8, the fourth conductive via V4, the fifth conductive via V5, the sixth conductive via V6, and the seventh conductive via V7 may cover discontinuous regions of the contact layer 242, the first metal layer M1, the second metal layer M2, and the first conductive via V1.

In some embodiments, the discontinuous regions of the contact layer 242, the first metal layer M1, the second metal layer M2, the third metal layer M3, the fourth metal layer M4, and the first conductive via V1, the second conductive via V2, and the third conductive via V3 may overlap each other, and they have different widths W1C. For example, the width W1C-01 of the discontinuous region of the contact layer 242, the width W1C-1 of the discontinuous region of the first metal layer M1, the width W1C-2 of the discontinuous region of the second metal layer M2, the width W1C-3 of the discontinuous region of the third metal layer M3, and he width W1C-4 of the discontinuous region of the fourth metal layer M4 may decrease gradually toward the top surface 240CT of the seal ring 240C.

In some embodiments, a sidewall 242S of the contact layer 242, a sidewall M1S of the first metal layer M1, a sidewall M2S of the second metal layer M2, a sidewall M3S of the third metal layer M3, and a sidewall M4S of the fourth metal layer M4 used to define the hole HC are not aligned with other.

Similarly, the widths of the discontinuous regions of the first conductive via V1, the second conductive via V2, and the third conductive via V3 may decrease gradually toward the top surface 240CT of the seal ring 240C.

In some embodiments, the hole HC may extend into the silicon layer 202-2 of the semiconductor substrate 202. The width W1C-00 of the discontinuous region of the silicon layer 202-2 may be wider than the width W1C-01 of the discontinuous region of the contact layer 242. In some embodiments, a sidewall 202-2S of the silicon layer 202-2 of the semiconductor substrate 202 used to define the hole HC is not aligned with the corresponding sidewalls 242S, M1S, M2S, M3S, and M4S.

In some embodiments, the width W1C of the discontinuous regions of the contact layer 242, the first metal layer M1, the second metal layer M2, the third metal layer M3, the fourth metal layer M4, and the first conductive via V1, the second conductive via V2, and the third conductive via V3 may also serve as the width W1C of the hole HC. In some embodiments, the width W1C of the hole HC may decrease gradually toward the top surface 240CT of the seal ring 240C.

In the cross-section view along the extending direction of the seal ring 240C close to the hole HC, the hole HC may have a reverse taper shape.

In some embodiments, the SSC 350 is located in discontinuous regions of the silicon layer 202-2, the contact layer 242, the first metal layer M1, the second metal layer M2, the third metal layer M3, the fourth metal layer M4, and the first conductive via V1, the second conductive via V2, and the third conductive via V3.

In some embodiments, the bottom surface 350B of the SSC 350 may be flush with the bottom surface 202-2B of the silicon layer 202-2. The top surface 350T of the SSC 350 may be flush with the bottom surface 242B of the contact layer 242 (i.e., the bottom surface of the seal ring 240C).

In some embodiments, the spacing S1C between the hole HC and the top surface 350T of the SSC 350 is greater than as the width W2 of the SSC 350. In some embodiments, the maximum spacing S2C between the hole HC and the side surface 350S of the SSC 350 is the same as the width W2 of the SSC 350, such as about 2-3 μm. In some embodiments, the maximum width W1C of the hole HC is substantially the same as three times the width W2 of the SSC 350, such as about 6-9 μm. In some embodiments, the minimum width W1C of the hole HC may smaller than the width W2 of the SSC 350.

When the spacing S1C, the maximum spacing S2C, and the maximum width W1C are maintained within appropriate limits, the seal ring 240C can effectively prevent undesired moisture from penetrating and reaching the internal circuit 210. Furthermore, by appropriately setting spacing S1C and spacing S2C, signal transmission through the SSC 350 can be made more stable and reliable, thereby reducing interference from the metal layers.

The photonic integrated circuit 500C aims to redesign the seal ring 240C having a reverse taper hole HC formed at least in the bottom metal layer (e.g., the first metal layer M1) and the metal layer (e.g., the second metal layer M2) that is immediately over the bottom metal layer in the seal ring 240C. In addition, the hole HC may extend into a portion of the semiconductor substrate (e.g., the silicon layer 202-2 of the semiconductor substrate 202). The seal ring 240C can block moisture while still enabling the SSC's (e.g., the SSC 350) function, thus enhancing the chip's durability and performance. This novel seal ring 240C can maintain light access but prevents moisture ingress. The seal ring 240C include a narrow hole to minimize copper loss (the discontinuous area of the seal ring 240C) and to position the metal as close as possible to the SSC 350. The photonic integrated circuit 500C may further reduce the size of the hole HC of the seal ring and minimize moisture ingress. In some embodiments, the hole HC can be gradually closed and sealed at the upper metal layers form the fifth metal layer M5 or the sixth metal layer M6. In some embodiments, the bottom surface 350B of the SSC 350 may be flush with the bottom surface 202-2B of the silicon layer 202-2.

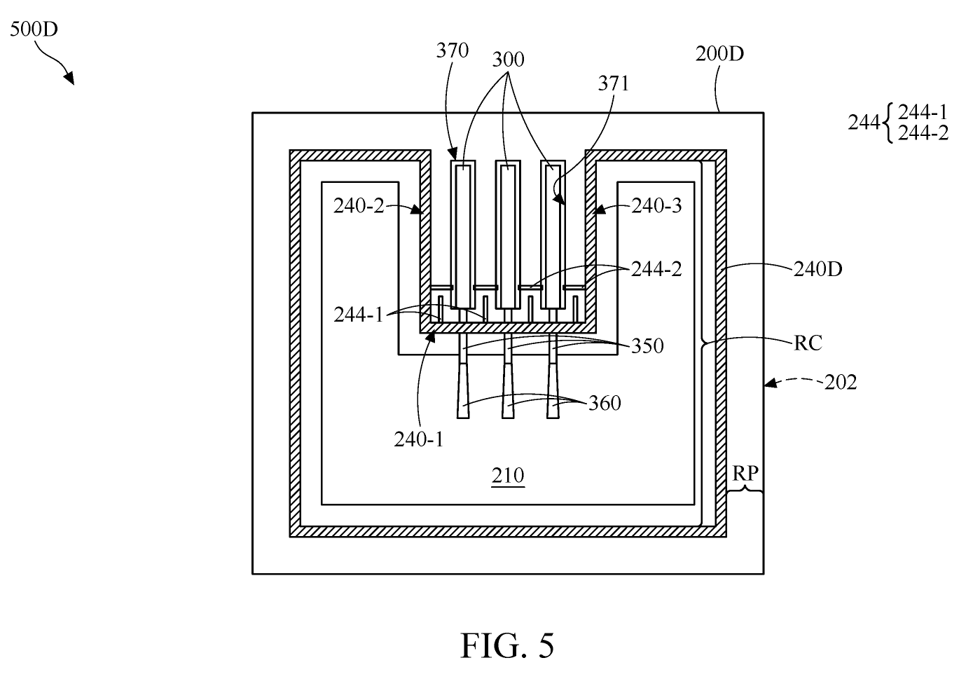

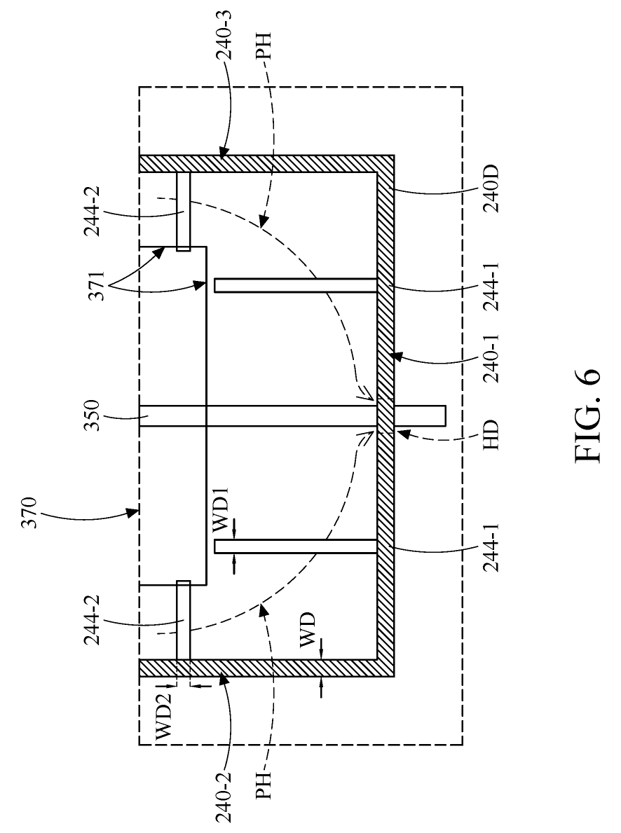

FIG. 5 is a schematic top view of a photonic integrated circuit 500D in accordance with some embodiments of the disclosure. FIG. 6 is an enlarge view of the photonic integrated circuit 500D in accordance with some embodiments of the disclosure shown in FIG. 5. Elements of the embodiments that are the same or similar to those previously described with reference to FIGS. 1-4 are not repeated herein, in the interests of brevity. For illustration, dielectric layers of an interconnect structure of the photonic integrated circuit 500D are omitted in FIG. 5.

As shown in FIGS. 1 and 5, the difference between the photonic integrated circuit 500A (or the photonic integrated circuits 500B and 500C) and the photonic integrated circuit 500D at least includes that the photonic integrated circuit 500D may include a seal ring 240D having one or more barrier bars 244.

As shown in FIGS. 5 and 6, the photonic integrated circuit 500D includes a chip 200D, one or more external fibers 300 and a spot-size converter (SSC) 350.

The chip 200D may include a semiconductor substrate 202, an internal circuit 210, dielectric layers (the same or similar to the dielectric layers 230 of the photonic integrated circuits 500A-500C) and the seal ring 240D. The chip 200D may include at least one V-groove 370, and an external fiber 300 may be disposed within the V-groove 370. The number of V-grooves 370 may correspond to the number of external fibers 300. The at least one V-groove 370 is located outside the seal ring 240D and is positioned adjacent to (i.e., close to) the seal ring 240D. Each V-groove 370 may be a V-shaped trench formed on the semiconductor substrate 202. A gap may exist between an inner sidewall 371 of the V-groove 370 and the external fiber 300 positioned therein. The gap may be filled with a dielectric material. In some embodiments, as shown in FIGS. 5 and 6, the photonic integrated circuit 500D includes three V-grooves 370 and three external fibers 300. The closer a V-groove 370 is to the top surface of the semiconductor substrate 202, the larger its opening width, thereby facilitating secure and stable positioning of the external fiber 300.

The seal ring 240D is disposed on the oxide layer of the semiconductor substrate 202 of the chip 200D. The seal ring 240D is located between the circuit region RC and the peripheral region RP and surrounds the circuit region RC. In addition, the seal ring 240D may continuously surround the internal circuit 210 and the waveguide 360. For example, the seal ring 240D may have the same or a similar structure as the seal rings 240A/240B/240C. In some embodiments, the seal ring 240D includes a plurality of metal layers (M1–M8), and the hole HD is formed in only a portion (i.e., some) of the metal layers rather than in all of the metal layers. Alternatively, in some embodiments, the seal ring 240D may have a structure different from that of the seal rings 240A/240B/240C. For example, a difference between the seal ring 240D and the seal rings 240A/240B/240C is that the hole HD is formed through all of the metal layers (M1–M8). The hole HD is not formed in the dielectric layer 230 and/or the passivation layer 250 above the metal layers ML. For example, the seal ring 240D may be discontinuous and may include at least one break (opening) through which the SSC 350 passes. More specifically, each of the metal layers (M1–M8) in the metal layers ML includes a corresponding break, such that the seal ring 240D is interrupted in all of the metal layers. Accordingly, the break (opening) interrupts the seal ring 240D, thereby forming a discontinuous seal ring 240D. In some embodiments, the break (opening) is located in the first ring portion 240-1 of the seal ring 240D. In some embodiments, the seal ring 240D may include a hole (discontinuous region) HD for the SSC 350 to pass through it. In some embodiments, the hole HD of the seal ring 240D may have a design the same or similar to the designs of the hole HA of the seal ring 240A or the hole HB of the seal ring 240B.

As shown in FIGS. 5 and 6, the seal ring 240D further includes one or more barrier bars 244 (including barrier bars 244-1 and 244-2). The barrier bars 244 are disposed nearby the hole HD of the seal ring 240D. The barrier bars 244 may be disposed in the space between the second ring portion 240-2 and the third ring portion 240-3. In some embodiments, an angle between a longitudinal (lengthwise) extension direction of the barrier bars 244 and a longitudinal (lengthwise) extension direction of the SSC 350 (or the V-groove 370 or the external fiber 300) may range from 0° to 180°. At least one barrier bar 244 simultaneously contacts both the seal ring 240D and the inner sidewall 371 of the V-groove 370. By providing this simultaneous contact with the seal ring 240D and the inner sidewall 371, at least one barrier bar 244 can effectively inhibit ingress of impurities (e.g., moisture) and protect the internal circuit 210, even when the seal ring 240D is discontinuous.

The barrier bar 244 is disposed outside the seal ring 240D. The barrier bar 244 may be arranged to block a path PH of moisture diffusion through the hole HD of the seal ring 240D, thereby preventing the moisture from entering the internal circuit 210.

In some embodiments, the barrier bars 244 may include the barrier bars 244-1 and 244-2. Each of the barrier bars 244-1 and 244-2 is separated from the internal circuit 210 through the seal ring 240D.

In some embodiments, the barrier bars 244-1 are disposed on opposite sides of the SSC 350 and extend substantially parallel to each other. That is, one barrier bar 244-1 is disposed on each side of the SSC 350. The barrier bars 244-1 are connected to and in contact with the first ring portion 240-1 of the seal ring 240D. In some embodiments, the angle between the longitudinal (lengthwise) extension direction of the barrier bars 244-1 and the longitudinal (lengthwise) extension direction of the SSC 350 (or the V-groove 370 or the external fiber 300) can be greater than or equal to 0 degrees and less than 90 degrees. In some embodiments, the longitudinal (lengthwise) extension direction of the barrier bars 244-1 may be parallel to the longitudinal (lengthwise) extension direction of the SSC 350 (or the V-groove 370 or the external fiber 300). Furthermore, the barrier bars 244-1 may intersect the path PH of moisture diffusion.

In some embodiments, the barrier bar 244-1 is connected to the seal ring 240D. Since the path PH of moisture diffusion close to the hole HD of the seal ring 240D is substantially formed along the seal ring 240D, the longitudinal (lengthwise) extension direction of the barrier bar 244-1 may be vertical to the extending direction of the portion (the first ring portion 240-1) of the seal ring 240D connected to the barrier bar 244-1. Alternatively, the barrier bar 244-1 is separated from the seal ring 240D. In some embodiments, the barrier bar 244-1 may extend in a straight line and may or may not contact the corresponding inner sidewall 371 of the V-groove 370. In some embodiments, the barrier bar 244-1 simultaneously contacts both the seal ring 240D (the first ring portion 240-1) and the inner sidewall 371 of the V-groove 370. In some embodiments, the barrier bar 244-1 may contact the inner sidewall 371 and extend beyond it (i.e., into the corresponding V-groove 370). However, the barrier bar 244-1 does not contact the external fiber 300. In other words, the barrier bar 244-1 is spaced apart from the external fiber 300.

In some embodiments, the barrier bar 244-2 is disposed overlapping the SSC 350. In some embodiments, the angle between the longitudinal (lengthwise) extension direction of the barrier bar 244-2 and the longitudinal (lengthwise) extension direction of the SSC 350 (or the V-groove 370 or the external fiber 300) may be greater than 0 degrees and less than or equal to 90 degrees. In some embodiments, the longitudinal (lengthwise) extension direction of the barrier bar 244-2 may be vertical to (or perpendicular to) the longitudinal (lengthwise) extension direction of the SSC 350 (or the V-groove 370 or the external fiber 300). Furthermore, the barrier bar 244-2 may intersect (e.g., substantially vertical to) the path PH of moisture diffusion. In some embodiments, the barrier bar 244-1 contacts the seal ring 240D (the first ring portion 240-1) and extends toward the barrier bar 244-2. In some embodiments, the first barrier bar 244-1 and the second barrier bar 244-2 contact different ring portions of the seal ring 240D. For example, as shown in FIGS. 5 and 6, the first barrier bar 244-1 contacts the first ring portion 240-1 of the seal ring 240D, whereas the second barrier bar 244-2 contacts the second ring portion 240-2 and the third ring portion 240-3 of the seal ring 240D.

In some embodiments, the barrier bar 244-2 is connected to the seal ring 240D. The barrier bar 244-2 is connected to the second ring portion 240-2 and/or the third ring portion 240-3 of the seal ring 240D. The barrier bar 244-2 contacts to the second ring portion 240-2 and/or the third ring portion 240-3 of the seal ring 240D. In some embodiments, the barrier bar 244-2 simultaneously contacts both the seal ring 240D and the inner sidewall 371 of the V-groove 370. Since the path PH of moisture diffusion close to the hole HD of the seal ring 240D is substantially formed along the seal ring 240D, the longitudinal (lengthwise) extension direction of the barrier bar 244-2 may be vertical to the extending direction of the portion of the seal ring 240D connected to the barrier bar 244-2. Alternatively, the barrier bar 244-2 is separated from the seal ring 240D. In some embodiments, the barrier bar 244-2 may extend in a straight line and may contact the corresponding inner sidewall 371 of the V-groove 370. The barrier bar 244-2 may contact the seral ring 240D. When multiple SSCs 350 (and corresponding external fibers 300) are provided, a portion of the barrier bar 244-2 located between two adjacent external fibers 300 may contact the inner sidewalls 371 of the two corresponding V-grooves 370. In addition, a portion of the barrier bar 244-2 located between an external fiber 300 and the seal ring 240D may contact the inner sidewall 371 of the corresponding V-groove 370 and the seal ring 240D (the second ring portion 240-2 or the third ring portion 240-3). In some embodiments, the barrier bar 244-2 may extend beyond the inner sidewall 371 and into the corresponding V-groove 370. However, the barrier bar 244-2 does not contact the external fiber 300. In other words, the barrier bar 244-2 is spaced apart from the external fiber 300. Regardless of whether the seal ring 240D is continuous or discontinuous, because the barrier bar 244-2 at least contacts the corresponding inner sidewall 371 of the V-groove 370, ingress of impurities (e.g., moisture) into the internal circuit 210 can be reduced, thereby protecting the internal circuit 210. In addition, the barrier bar 244-1 having an extension direction different from that of the barrier bar 244-2 may be provided to further suppress ingress of impurities (e.g., moisture) into the internal circuit 210. In some embodiments, the longitudinal (lengthwise) extension direction of the barrier bar 244-2 is substantially perpendicular to the longitudinal (lengthwise) extension direction of the SSC 350 or the external fibers 300.

In some embodiments, the barrier bar 244-1 and the barrier bar 244-2 extend in different directions, corresponding (vertical to) to the extending directions of the connected portions of the seal ring 240D. As shown in FIGS. 4 and 5, for example, the longitudinal (lengthwise) extension direction of the barrier bar 244-2 is vertical to the longitudinal (lengthwise) extension direction of the barrier bar 244-1. The longitudinal (lengthwise) extension direction of the barrier bar 244-2 is vertical to the longitudinal (lengthwise) extension direction of the SSC 350. In some embodiments, the barrier bar 244-2 simultaneously contacts both the seal ring 240D and the inner sidewall 371 of the V-groove 370, whereas the barrier bar 244-1 contacts the seal ring 240D but does not contact the inner sidewall 371 of the V-groove 370 (e.g., the barrier bar 244-1 is spaced apart from the inner sidewall 371). This configuration simplifies the manufacturing process while effectively protecting the internal circuit 210. In some embodiments, both the barrier bar 244-2 and the barrier bar 244-1 simultaneously contact the seal ring 240D and the inner sidewall 371 of the V-groove 370, thereby more effectively protecting the internal circuit 210.

The barrier bars 244 may serve as dummy seal ring portions or extending portions of the seal ring 240D. Therefore, the barrier bar 244 may have a structure and material that are the same as or similar to those of the seal ring 240D.

In some embodiments, the barrier bars 244 and the seal ring 240D may include the same number of the metal layer ML and the same number of the conductive vias CV. In some embodiments, the width WD of the seal ring 240D is greater than the width WD1 of barrier bar 244-1 and the width WD2 of barrier bar 244-2. In addition, the width WD1 of barrier bar 244-1 may be the same as or different from the width WD2 of barrier bar 244-2.

In some embodiments, the barrier bar 244 may be connected to the seal ring 240D and grounded. Alternatively, the barrier bar 244 may be separated from the seal ring 240D and electrically floating.

The photonic integrated circuit 500C has advantages of the photonic integrated circuits 500A, 500B, and 50C. In addition, the photonic integrated circuit 500C aims to redesign the seal ring 240D having barrier bars 244 to further block a path PH of moisture diffusion through the hole HD of the seal ring 240D while still enabling the SSC's (e.g., the SSC 350) function, thus enhancing the chip's durability and performance. This could involve innovative new seal ring structure that maintains light access but prevents moisture ingress.

Embodiments provide a photonic integrated circuit. The photonic integrated circuit includes an internal circuit, a seal ring, and a spot-size converter (SSC). The seal ring continuously surrounds the internal circuit. The spot-size converter (SSC) is connected between the internal circuit and an external fiber. The seal ring includes a hole for the SSC to pass through.

In some embodiments, the seal ring includes a plurality of metal layers, wherein a first metal layer of the plurality of metal layers is discontinuous and a second metal layer of the plurality of metal layers is continuous.

In some embodiments, the SSC is located in a discontinuous region of the first metal layer.

In some embodiments, the second metal layer covers the first metal layer and the discontinuous region of the first metal layer.

In some embodiments, the maximum width of the hole is 9 um.

In some embodiments, a width of the hole decreases gradually toward a top surface of the seal ring.

In some embodiments, a bottom surface of the SSC is substantially flush with a bottom surface of the seal ring.

In some embodiments, the SSC is separated from the metal layers by a dielectric layer.

In some embodiments, the photonic integrated circuit further includes a V-groove and a first barrier bar. The V-groove is located outside the seal ring and positioned adjacent to the seal ring,. The external fiber is disposed within the V-groove. The first barrier bar contacts the seal ring and an inner sidewall of the V-groove. An angle between an extension direction of the first barrier bar and an extension direction of the SSC is greater than 0° and less than or equal to 90.

In some embodiments, the longitudinal (lengthwise) extension direction of the first barrier bar is parallel to the longitudinal (lengthwise) extension direction of the SSC.

In some embodiments, the photonic integrated circuit further includes a second barrier bar contacting the seal ring and extending toward the first barrier bar. An angle between an extension direction of the second barrier bar and an extension direction of the SSC is greater than or equal to 0° and less than 90°.

In some embodiments, the longitudinal (lengthwise) extension direction of the second barrier bar is vertical to an extending direction of a portion of the seal ring connected to the second barrier bar.

In some embodiments, the longitudinal (lengthwise) extension direction of the second barrier bar is vertical to the longitudinal (lengthwise) extension direction of the first barrier bar.

In some embodiments, the photonic integrated circuit further includes a third barrier bar disposed nearby the hole, wherein the first barrier bar and the third barrier bar are disposed on opposite sides of the SSC and are parallel to each other.

In some embodiments, each of the first barrier bar, the second barrier bar and the third barrier bar is connected to the seal ring or separated from the seal ring.

In some embodiments, a width of the seal ring is greater than a width of any of the first barrier bar and the second barrier bar.

In some embodiments, the seal ring and any of the first barrier bar, and the second barrier bar includes the same number of metal layers of the seal ring.

In some embodiments, each of the first barrier bar and the second barrier bar a is separated from the internal circuit through the seal ring.

In some embodiments, the first barrier bar and the second barrier bar contact different ring portions of the seal ring.

Embodiments provide a photonic integrated circuit. The photonic integrated circuit includes an internal circuit, a seal ring, and a spot-size converter (SSC). The seal ring surrounds the internal circuit. The spot-size converter (SSC) is connected between the internal circuit and an external fiber. The seal ring includes a plurality of metal layers and a hole to allow the SSC to pass through. The hole is formed in a portion of the plurality of metal layers.

In some embodiments, the photonic integrated circuit further including at least one barrier bar disposed nearby the hole and separated from the internal circuit through the seal ring.

In some embodiments, said the longitudinal (lengthwise) extension direction of barrier bar is disposed parallel or vertical to the longitudinal (lengthwise) extension direction of the SSC.

In some embodiments, the photonic integrated circuit further includes a V-groove located outside the seal ring and positioned adjacent to the seal ring, wherein the external fiber is disposed within the V-groove. The at least one barrier bar contacts the seal ring and an inner sidewall of the V-groove, and the at least one barrier bar is spaced apart from the external fiber.

Embodiments provide a photonic integrated circuit. The photonic integrated circuit includes an internal circuit, a seal ring, a spot-size converter (SSC), a V-groove, and a first barrier bar. The seal ring surrounds the internal circuit. The spot-size converter (SSC) passes through an opening in the seal ring and connected between the internal circuit and an external fiber. The V-groove is located outside the seal ring and positioned adjacent to the seal ring, wherein the external fiber is disposed within the V-groove. The first barrier bar is connected to the seal ring. The first barrier bar contacts an inner sidewall of the V-groove and is spaced apart from the external fiber.

In some embodiments, the seal ring includes a first ring portion and a second ring portion connected to the first ring portion. The opening is located in the first ring portion, and the first barrier bar contacts the second ring portion.

In some embodiments, the photonic integrated circuit further includes a second barrier bar extending in a direction different from an extension direction of the first barrier bar. The second barrier bar contacts the first ring portion.

In some embodiments, the second barrier bar contacts the inner sidewall of the V-groove and is spaced apart from the external fiber.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A photonic integrated circuit, comprising:
an internal circuit;
a seal ring continuously surrounding the internal circuit; and
a spot-size converter (SSC) connected between the internal circuit and an external fiber,
wherein the seal ring comprises a hole for the SSC to pass through.

2. The photonic integrated circuit as claimed in claim 1, wherein the seal ring comprises a plurality of metal layers, wherein a first metal layer of the plurality of metal layers is discontinuous and a second metal layer of the plurality of metal layers is continuous.

3. The photonic integrated circuit as claimed in claim 2, wherein the SSC is located in a discontinuous region of the first metal layer.

4. The photonic integrated circuit as claimed in claim 3, wherein the second metal layer covers the first metal layer and the discontinuous region of the first metal layer.

5. The photonic integrated circuit as claimed in claim 1, wherein a width of the hole decreases gradually toward a top surface of the seal ring.

6. The photonic integrated circuit as claimed in claim 1, wherein a bottom surface of the SSC is substantially flush with a bottom surface of the seal ring or a bottom surface of a contact layer of the seal ring.

7. The photonic integrated circuit as claimed in claim 2, wherein the SSC is separated from the metal layers by a dielectric layer.

8. The photonic integrated circuit as claimed in claim 1, further comprising:
a V-groove located outside the seal ring and positioned adjacent to the seal ring, wherein the external fiber is disposed within the V-groove; and
a first barrier bar contacting the seal ring and an inner sidewall of the V-groove, wherein an angle between an extension direction of the first barrier bar and an extension direction of the SSC is greater than 0° and less than or equal to 90°.

9. The photonic integrated circuit as claimed in claim 8, further comprising:
a second barrier bar contacting the seal ring and extending toward the first barrier bar, wherein an angle between an extension direction of the second barrier bar and an extension direction of the SSC is greater than or equal to 0° and less than 90°.

10. The photonic integrated circuit as claimed in claim 9, wherein a width of the seal ring is greater than a width of any of the first barrier bar, and the second barrier bar .

11. The photonic integrated circuit as claimed in claim 10, wherein the seal ring and any of the first barrier bar and the second barrier bar comprise the same number of metal layers of the seal ring.

12. The photonic integrated circuit as claimed in claim 9, wherein each of the first barrier bar and the second barrier bar is separated from the internal circuit through the seal ring.

13. The photonic integrated circuit as claimed in claim 9, wherein the first barrier bar and the second barrier bar contact different ring portions of the seal ring.

14. A photonic integrated circuit, comprising:
an internal circuit;
a seal ring surrounding the internal circuit; and
a spot-size converter (SSC) connected between the internal circuit and an external fiber,
wherein the seal ring comprises a plurality of metal layers and a hole to allow the SSC to pass through, and the hole is formed in a portion of the plurality of metal layers.

15. The photonic integrated circuit as claimed in claim 14, wherein the photonic integrated circuit further comprises at least one barrier bar disposed nearby the hole and separated from the internal circuit through the seal ring.

16. The photonic integrated circuit as claimed in claim 15, further comprising:
a V-groove located outside the seal ring and positioned adjacent to the seal ring, wherein the external fiber is disposed within the V-groove; and
wherein the at least one barrier bar contacts the seal ring and an inner sidewall of the V-groove, and the at least one barrier bar is spaced apart from the external fiber.

17. A photonic integrated circuit, comprising:
an internal circuit;
a seal ring surrounding the internal circuit;
a spot-size converter (SSC) passing through an opening in the seal ring and connected between the internal circuit and an external fiber;
a V-groove located outside the seal ring and positioned adjacent to the seal ring, wherein the external fiber is disposed within the V-groove; and
a first barrier bar connected to the seal ring, wherein the first barrier bar contacts an inner sidewall of the V-groove and is spaced apart from the external fiber.

18. The photonic integrated circuit as claimed in claim 17, wherein the seal ring comprises a first ring portion and a second ring portion connected to the first ring portion, wherein the opening is located in the first ring portion, and the first barrier bar contacts the second ring portion.

19. The photonic integrated circuit as claimed in claim 18, further comprising:
a second barrier bar extending in a direction different from an extension direction of the first barrier bar, wherein the second barrier bar contacts the first ring portion.

20. The photonic integrated circuit as claimed in claim 19, wherein the second barrier bar contacts the inner sidewall of the V-groove and is spaced apart from the external fiber.
